(19) United States
(12) Patent Application Publication
(10) Pub. No.: US 2026/0119487 A1
(43) Pub. Date: Apr. 30, 2026

(54) HYBRID TABLE FAST BULK LOAD FOR INSERT AND COPY

(71) Applicant: Snowflake Inc., Bozeman, MT (US)

(72) Inventors: Lishi Jiang, Bellevue, WA (US); Alexander Miller, Bozeman, MT (US); Jeffrey Plaisance, Austin, TX (US); Dimitrios Tsirogiannis, Belmont, CA (US); Zhaohui Zhang, Redwood City, CA (US)

(21) Appl. No.: 18/933,334

(22) Filed: Oct. 31, 2024

(51) Int. Cl. G06F 16/2453; G06F 16/23

(52) U.S. Cl. CPC G06F 16/24542; G06F 16/2386

(57) ABSTRACT

The subject technology receives a query, the query including a statement to perform a loading operation into a table. The subject technology compiles the query to generate an initial query plan. The subject technology determines a cardinality estimate of the loading operation into the table. The subject technology determines whether the cardinality estimate is greater than a first threshold value. The subject technology, in response to the cardinality estimate being greater than the first threshold value, updates the initial query plan to generate a query plan, the query plan including a native insert subplan and a bulk load subplan. The subject technology sends the query plan to an execution node for execution.

### TECHNICAL FIELD

Embodiments of the disclosure relate generally to data processing systems, specifically to methods and systems for optimizing bulk data loading operations in database management systems.

### BACKGROUND

Data platforms are widely used for data storage and data access in computing and communication contexts. With respect to architecture, a data platform could be an on-premises data platform, a network-based data platform (e.g., a cloud-based data platform), a combination of the two, and/or include another type of architecture. With respect to type of data processing, a data platform could implement online transactional processing (OLTP), online analytical processing (OLAP), a combination of the two, and/or another type of data processing. Moreover, a data platform could be or include a relational database management system (RDBMS) and/or one or more other types of database management systems.

A data platform may store database data (e.g., a table) in multiple storage units, which may be referred to as partitions, micro-partitions, and/or by one or more other names. A database may be organized as records (e.g., rows or a collection of rows) that each include one or more attributes (e.g., columns). In an example, multiple storage units of a database can be stored in a block and multiple blocks can be grouped into a single file. That is, a database can be organized into a set of files where each file includes a set of blocks, where each block includes a set of more granular storage units such as partitions. It should be understood that the terms “row” and “column” are used for illustration purposes and these terms are interchangeable. For example, data arranged in a column of a table can similarly be arranged in a row of the table.

Users and/or executing processes that are associated with a given customer account may, via one or more types of clients, be able to cause data to be ingested into the database, and may also be able to manipulate the data, add additional data, remove data, run queries against the data, generate views of the data, and so forth.

When certain information is to be extracted from a database, a query statement may be executed against the database data. A data platform may process the query and return certain data according to one or more query predicates that indicate what information should be returned by the query. The data platform extracts specific data from the database and formats that data into a readable form.

### BRIEF DESCRIPTION OF THE DRAWINGS

The present disclosure will be understood more fully from the detailed description given below and from the accompanying drawings of various embodiments of the disclosure.

FIG. 1 illustrates an example computing environment that includes a data platform, in accordance with some embodiments of the present disclosure.

FIG. 2 is a block diagram illustrating components of a compute service manager of the cloud data platform, in accordance with some embodiments of the present disclosure

FIG. 3 illustrates an example of a query plan providing an adaptive bulk load, in accordance with an embodiment of the subject technology.

FIG. 4 illustrates an example of a data processing flow for adaptive bulk load execution involving various components of the data platform, in accordance with an embodiment of the subject technology.

FIG. 5 is a flow diagram illustrating operations of a database system in performing a method, in accordance with some embodiments of the present disclosure.

FIG. 6 is a flow diagram illustrating operations of a database system in performing a method, in accordance with some embodiments of the present disclosure.

FIG. 7 illustrates a diagrammatic representation of a machine in the form of a computer system within which a set of instructions may be executed for causing the machine to perform any one or more of the methodologies discussed herein, in accordance with some embodiments of the present disclosure.

### DETAILED DESCRIPTION

Reference will now be made in detail to specific example embodiments for carrying out the inventive subject matter. Examples of these specific embodiments are illustrated in the accompanying drawings, and specific details are set forth in the following description to provide a thorough understanding of the subject matter. It will be understood that these examples are not intended to limit the scope of the claims to the illustrated embodiments. On the contrary, they are intended to cover such alternatives, modifications, and equivalents as may be included within the scope of the disclosure.

In database systems, performing transactions on a given database can be supported. To facilitate that a given transaction is committed to a table, existing database systems can employ varying approaches including Online Transactional Processing (OLTP) techniques. OLTP refers to a category of data processing that involves transaction-oriented tasks. In an example, OLTP involves inserting, updating, and/or deleting varying amounts of data in a given database. OLTP can deal with large numbers of transactions by a large number of users. In some example embodiments, an OLTP database can be implemented as a key-value database in which the data is managed as key-value pairs (e.g., provided in FoundationDB or “Foundation DB” or “FDB” as referred to herein).

The subject system supports a table format referred to as a hybrid table, where such a table format includes two key components:
1. An in-memory key-value store for efficient point access
2. A blob format to support efficient scans

In the realm of data management, efficient handling of large data sets during operations remains a significant challenge. Traditional methods often rely on implementations that may not perform optimally when dealing with substantial data volumes. This inefficiency becomes particularly evident in scenarios where rapid data loading is necessary.

As discussed herein, loading refers to a process of inserting or copying large volumes of data into database tables. This process is particularly important for efficiently handling bulk data operations in cloud-based systems.

Existing solutions offer some benefits but come with limitations. Some existing techniques do not support specific table structures, necessitating modifications to applications to accommodate these methods. Additionally, the performance of existing implementations can degrade with larger data sets, leading to increased processing times and resource consumption. Such constraints highlight the need for a more adaptive and dynamic approach to improve performance across various scenarios, including different structures and data sizes.

In an example, there are two main types of loading operations:
1. Insert: This involves adding new rows of data into existing tables.
2. Copy: This operation is used to transfer data from external sources into database tables.

As discussed further herein, embodiments enable hybrid table bulk loading that optimizes such loading operations, especially for large datasets. Moreover, the subject technology introduces an adaptive approach that can dynamically choose between two loading techniques:
1. Standard Insert: a native way of inserting data row by row.
2. Bulk Load: a more efficient way for loading large volumes of data, which utilizes a FDB (FoundationDB) bulk load API.

The subject system determines which technique to use based on factors such as the amount of data being loaded, the emptiness of the target table, and runtime conditions. Such an adaptive approach can provide improved performance and cost-effectiveness when loading data into cloud database tables.

Thus, embodiments of the subject technology improve the performance of insert and copy operations on hybrid tables, particularly when handling large data volumes. More specifically, the subject system can improve the performance of insert and copy operations on hybrid tables, particularly when handling large data sets. In an example, the subject system employs an adaptive and dynamic approach to optimize execution based on varying scenarios, such as different tables and data sizes.

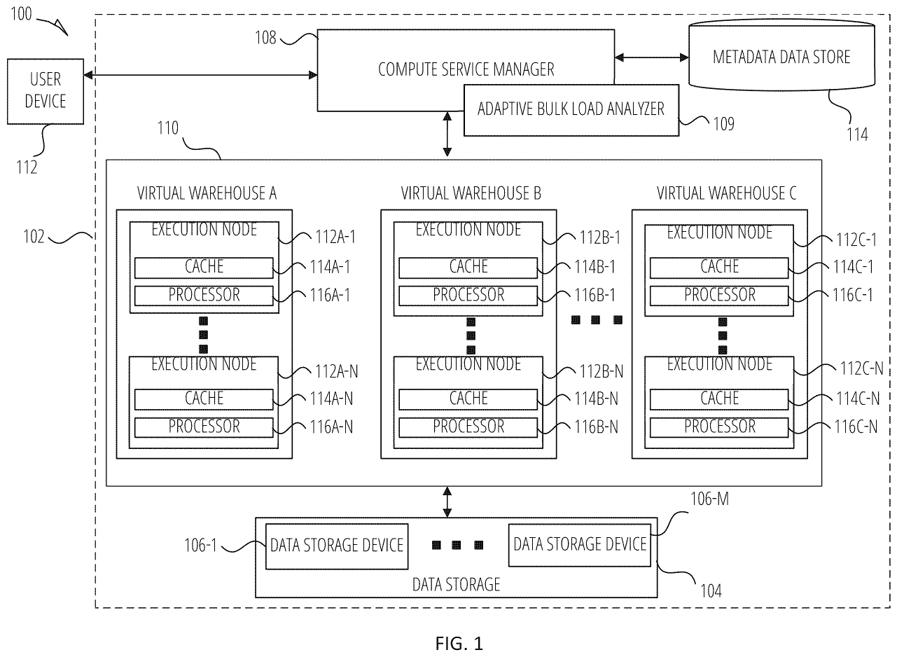

FIG. 1 illustrates an example computing environment 100 that includes a data platform 102, in accordance with some embodiments of the present disclosure. To avoid obscuring the inventive subject matter with unnecessary detail, various functional components that are not germane to conveying an understanding of the inventive subject matter have been omitted from FIG. 1. However, a skilled artisan will readily recognize that various additional functional components may be included as part of the computing environment 100 to facilitate additional functionality that is not specifically described herein.

As shown, the data platform 102 comprises a three-tier architecture: a compute service manager 108 coupled to a metadata data store 114, an execution platform 110, and data storage 104. The data platform 102 hosts and provides data access, management, reporting, and analysis services to multiple client accounts. Administrative users can create and manage identities (e.g., users, roles, and groups) and use permissions to allow or deny access to the identities to resources and services. The data platform 102 is used for reporting and analysis of integrated data from one or more disparate sources including storage devices within the data storage 104. The data storage 104 comprises a plurality of computing machines and provides on-demand computer system resources such as data storage and computing power to the data platform 102.

The compute service manager 108 includes multiple services that coordinate and manage operations of the data platform 102. For example, the compute service manager 108 is responsible for performing query optimization and compilation as well as managing clusters of compute nodes that perform query processing (also referred to as “virtual warehouses”). The compute service manager 108 can support any number of client accounts such as end users providing data storage and retrieval requests, system administrators managing the systems and methods described herein, and other components/devices that interact with compute service manager 108.

The compute service manager 108 is also coupled to the metadata data store 114. The metadata data store 114 stores metadata pertaining to various functions and aspects associated with the data platform 102 and its users. The metadata data store 114 also includes a summary of data stored in data storage 104 as well as data available from local caches. Additionally, the metadata data store 114 includes information regarding how data is organized in the data storage 104 and the local caches.

As shown, the compute service manager 108 includes an adaptive bulk load analyzer 109 that is responsible for performing operations related to improving DML queries, including at least insert and copy operations on hybrid tables, as discussed further herein. Further details of the operation of the adaptive bulk load analyzer 109 are discussed below.

The compute service manager 108 is also in communication with a user device 112. The user device 112 corresponds to a user of one of the multiple client accounts supported by the data platform 102. In some implementations, the compute service manager 108 does not receive any direct communications from the user device 112 and only receives communications concerning jobs from a queue within the data platform 102.

The compute service manager 108 is also coupled to the metadata data store 114. The metadata data store 114 stores metadata pertaining to various functions and aspects associated with the data platform 102 and its users. The metadata data store 114 also includes a summary of data stored in data storage 104 as well as data available from local caches. Additionally, the metadata data store 114 includes information regarding how data is organized in the data storage 104 and the local caches.

The compute service manager 108 is further coupled to the execution platform 110, which includes multiple virtual warehouses (computing clusters) that execute various data storage and data retrieval tasks. As an example, a set of processes on a compute node executes at least a portion of a query plan compiled by the compute service manager 108. As shown, the execution platform 110 includes virtual warehouse A, virtual warehouse B, and virtual warehouse C. Each virtual warehouse includes multiple execution nodes that each includes a data cache and a processor. For example, as shown, virtual warehouse A includes execution node 112A-1 to 112A-N; execution node 112A-1 includes a cache 114A-1 and a processor 116A-1; and execution node 112A-N includes a cache 114A-N and a processor 116A-N. Similarly, in this example, virtual warehouse B includes execution node 112B-1 to 112B-N; execution node 112B-1 includes a cache 114B-1 and a processor 116B-1; and execution node 112B-N includes a cache 114B-N and a processor 116B-N. Additionally, virtual warehouse C includes execution node 112C-1 to 112C-N; execution node 112C-1 includes a cache 114C-1 and a processor 116C-1; and execution node 112C-N includes an execution node 112C-N and a processor 116C-N.

Each execution node of the execution platform 110 is assigned to processing one or more data storage and/or data retrieval tasks. Hence, the virtual warehouses can execute multiple tasks in parallel utilizing the multiple execution nodes. For example, a virtual warehouse may handle data storage and data retrieval tasks associated with an internal service, such as a clustering service, a materialized view refresh service, a file compaction service, a storage procedure service, or a file upgrade service. In other implementations, a particular virtual warehouse may handle data storage and data retrieval tasks associated with a particular data storage system or a particular category of data.

In some examples, the execution nodes of the execution platform 110 are stateless with respect to the data the execution nodes are caching. That is, the execution nodes do not store or otherwise maintain state information about the execution node or the data being cached by a particular execution node, in these examples. Thus, in the event of an execution node failure, the failed node can be transparently replaced by another node. Since there is no state information associated with the failed execution node, the new (replacement) execution node can easily replace the failed node without concern for recreating a particular state.

The execution platform 110 may include any number of virtual warehouses. Additionally, the number of virtual warehouses in the execution platform 110 is dynamic, such that new virtual warehouses are created when additional processing and/or caching resources are needed. Similarly, existing virtual warehouses may be deleted when the resources associated with the virtual warehouse are no longer necessary.

Although each virtual warehouse shown in FIG. 1 includes three execution nodes, a particular virtual warehouse may include any number of execution nodes. Further, the number of execution nodes in a virtual warehouse is dynamic, such that new execution nodes are created when additional demand is present, and existing execution nodes are deleted when they are no longer necessary. Additionally, although the execution nodes shown in the example of FIG. 1 each include a single data cache and a single processor, in other examples, execution nodes can contain any number of processors and any number of caches. Also, the caches may vary in size among the different execution nodes.

In some examples, the virtual warehouses of the execution platform 110 operate on the same data, but each virtual warehouse has its own execution nodes with independent processing and caching resources. This configuration allows requests on different virtual warehouses to be processed independently and with no interference between the requests. This independent processing, combined with the ability to dynamically add and remove virtual warehouses, supports the addition of new processing capacity for new users without impacting the performance observed by the existing users.

Although virtual warehouses A, B, and C are illustrated with an association with the same execution platform 110, the virtual warehouses may be implemented using multiple computing systems at multiple geographic locations. For example, virtual warehouse A can be implemented by a computing system at a first geographic location, while virtual warehouses B and Care implemented by another computing system at a second geographic location. In some examples, these different computing systems are cloud-based computing systems maintained by one or more different entities.

The execution platform 110 is coupled to data storage 104. The data storage 104 comprises multiple data storage devices 106-1 to 106-M. In some embodiments, the data storage devices 106-1 to 106-M are cloud-based storage devices located in one or more geographic locations. For example, the data storage devices 106-1 to 106-M may be part of a public cloud infrastructure or a private cloud infrastructure. The data storage devices 106-1 to 106-M may be hard disk drives (HDDs), solid state drives (SSDs), storage clusters, Amazon S3™ storage systems or any other data storage technology. Additionally, the data storage 104 may include distributed file systems (e.g., Hadoop Distributed File Systems (HDFS)), object storage systems, and the like. In some examples, the data storage devices 106-1 to 106-M are managed and provided by a third-party data storage platform (e.g., AWS®, Microsoft Azure Blob Storage®, or Google Cloud Storage®).

Each virtual warehouse can access any of the data storage devices 106-1 to 106-M shown in FIG. 1. Thus, the virtual warehouses are not necessarily assigned to a specific data storage device 106-1 to 106-M and, instead, can access data from any of the data storage devices 106-1 to 106-M within the data storage 104. Similarly, each of the execution nodes shown in FIG. 1 can access data from any of the data storage devices 106-1 to 106-M. In some examples, a particular virtual warehouse or a particular execution node may be temporarily assigned to a specific data storage device, but the virtual warehouse or execution node may later access data from any other data storage device.

In some examples, communication links between elements of the computing environment 100 are implemented via one or more data communication networks. These data communication networks may utilize any communication protocol and any type of communication medium. In some examples, the data communication networks are a combination of two or more data communication networks (or sub-networks) coupled to one another.

As shown in FIG. 1, the data storage devices 106-1 to 106-M are decoupled from the computing resources associated with the execution platform 110. This architecture supports dynamic changes to the data platform 102 based on the changing data storage/retrieval needs as well as the changing needs of the users and systems. The support of dynamic changes allows the data platform 102 to scale quickly in response to changing demands on the systems and components within the data platform 102. The decoupling of the computing resources from the data storage devices supports the storage of large amounts of data without requiring a corresponding large amount of computing resources. Similarly, this decoupling of resources supports a significant increase in the computing resources utilized at a particular time without requiring a corresponding increase in the available data storage resources.

During typical operation, the data platform 102 processes multiple jobs determined by the compute service manager 108. These jobs are scheduled and managed by the compute service manager 108 to determine when and how to execute the job. For example, the compute service manager 108 may divide the job into multiple discrete tasks and may determine what data is needed to execute each of the multiple discrete tasks. The compute service manager 108 may assign each of the multiple discrete tasks to one or more execution nodes of the execution platform 110 to process the task. The compute service manager 108 may determine what data is needed to process a task and further determine which nodes within the execution platform 110 are best suited to process the task. Some nodes may have already cached the data needed to process the task and, therefore, be a good candidate for processing the task. Metadata stored in the metadata data store 114 assists the compute service manager 108 in determining which nodes in the execution platform 110 have already cached at least a portion of the data needed to process the task. One or more nodes in the execution platform 110 process the task using data cached by the nodes and, if necessary, data retrieved from the data storage 104.

The compute service manager 108, metadata data store 114, execution platform 110, and data storage 104 are shown in FIG. 1 as individual discrete components. However, each of the compute service manager 108, metadata data store 114, execution platform 110, and data storage 104 may be implemented as a distributed system (e.g., distributed across multiple systems/platforms at multiple geographic locations). Additionally, each of the compute service manager 108, metadata data store 114, execution platform 110, and data storage 104 can be scaled up or down (independently of one another) depending on changes to the requests received and the changing needs of the data platform 102. Thus, in the described embodiments, the data platform 102 is dynamic and supports regular changes to meet the current data processing needs.

As mentioned further herein, terms “file” and “micro-partition” or partition may each refer to a subset of database data and may be used interchangeably in some embodiments. The file metadata includes information about a micro-partition of the table. Further, metadata may be stored for each column of each micro-partition of the table. The metadata pertaining to a column of a micro-partition may be referred to as an expression property (EP) and may include any suitable information about the column, including for example, a minimum and maximum for the data stored in the column, a type of data stored in the column, a subject of the data stored in the column, versioning information for the data stored in the column, file statistics for all micro-partitions in the table, global cumulative expressions for columns of the table, and so forth. Each column of each micro-partition of the table may include one or more expression properties. It should be appreciated that the table may include any number of micro-partitions, and each micro-partition may include any number of columns. The micro-partitions may have the same or different columns and may have different types of columns storing different information. As discussed further herein, the subject technology provides a file system that includes “EP” files (expression property files), where each of the EP files stores a collection of expression properties about corresponding data. As described further herein, each EP file (or the EP files, collectively) can function similar to an indexing structure for micro-partition metadata. Stated another way, each EP file includes a “region” of micro-partitions, and the EP files are the basis for persistence, cache organization and organizing the multi-level structures of a given table's EP metadata. Additionally, in some implementations of the subject technology, a two-level data structure (also referred to as “2-level EP” or a “2-level EP file”) can at least store metadata corresponding to grouping expression properties and micro-partition statistics.

As mentioned above, a table of a database may include many rows and columns of data. One table may include millions of rows of data and may be very large and difficult to store or read. A very large table may be divided into multiple smaller files corresponding to micro-partitions. For example, one table may be divided into six distinct micro-partitions, and each of the six micro-partitions may include a portion of the data in the table. Dividing the table data into multiple micro-partitions helps to organize the data and to find where certain data is located within the table.

In an embodiment, the metadata data store 114 includes EP files (expression property files), where each of the EP files store a collection of expression properties about corresponding data. As mentioned before, EP files provide a similar function to an indexing structure into micro-partition metadata. Metadata may be stored for each column of each micro-partition of a given table.

In an example, a large source table may be (logically) organized as a set of regions in which each region can be further organized into a set of micro-partitions. Additionally, each micro-partition can be stored as a respective file in the subject system in an embodiment. Thus, the term “file” (or “data file”) as mentioned herein can refer to a micro-partition or object for storing data in a storage device or storage platform. In embodiments herein, each file includes data, which can be further compressed (e.g., using an appropriate data compression algorithm or technique) to reduce a respective size of such a file.

In some embodiments, metadata may be generated when changes are made to one or more source table(s) using a data manipulation language (DML), where such changes can be made by way of a DML statement. Examples of modifying data, using a given DML statement, may include updating, changing, merging, inserting, and deleting data into a source table(s), file(s), or micro-partition(s).

As shown in FIG. 1, the computing environment 100 separates the execution platform 110 from the data storage 104. In this arrangement, the processing resources and cache resources in the execution platform 110 operate independently of the data storage devices 106-1 to 106-M in the data storage 104. Thus, the computing resources and cache resources are not restricted to specific data storage devices 106-1 to 106-M. Instead, all computing resources and all cache resources may retrieve data from, and store data to, any of the data storage resources in the data storage 104.

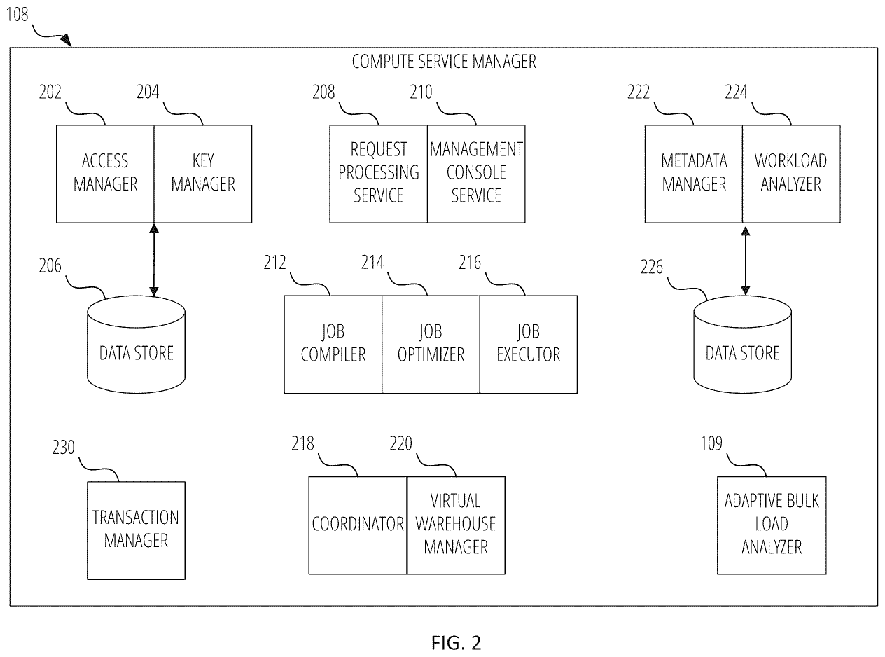

FIG. 2 is a block diagram illustrating components of the compute service manager 108, in accordance with some embodiments of the present disclosure. As shown in FIG. 2, the compute service manager 108 includes an access manager 202 and a key manager 204 coupled to a data store 206 that stores access information. Access manager 202 handles authentication and authorization tasks for the systems described herein. Key manager 204 manages storage and authentication of keys used during authentication and authorization tasks. For example, access manager 202 and key manager 204 manage the keys used to access data stored in remote storage devices (e.g., data storage devices in data storage 104).

A request processing service 208 manages received data storage requests and data retrieval requests (e.g., jobs to be performed on database data). For example, the request processing service 208 may determine the data necessary to process a received query (e.g., a data storage request or data retrieval request). The data may be stored in a cache within the execution platform 110 or in a data storage device in data storage 104.

A management console service 210 supports access to various systems and processes by administrators and other system managers. Additionally, the management console service 210 may receive a request to execute a job and monitor the workload on the system.

The compute service manager 108 also includes a job compiler 212, a job optimizer 214, and a job executor 216. The job compiler 212 parses a job into multiple discrete tasks and generates the execution code for each of the multiple discrete tasks. The job optimizer 214 determines the best method to execute the multiple discrete tasks based on the data that needs to be processed. The job optimizer 214 also handles various data pruning operations and other data optimization techniques to improve the speed and efficiency of executing the job. The job executor 216 executes the execution code for jobs received from a queue or determined by the compute service manager 108.

A job scheduler and coordinator 218 sends received jobs to the appropriate services or systems for compilation, optimization, and dispatch to the execution platform 110. For example, jobs may be prioritized and processed in that prioritized order. In some examples, the job scheduler and coordinator 218 identifies or assigns particular nodes in the execution platform 110 to process particular tasks.

A virtual warehouse manager 220 manages the operation of multiple virtual warehouses implemented in the execution platform 110. As discussed below, each virtual warehouse includes multiple execution nodes that each include a cache and a processor.

Additionally, the compute service manager 108 includes a configuration and metadata manager 222, which manages the information related to the data stored in the remote data storage devices and in the local caches (e.g., the caches in execution platform 110). The configuration and metadata manager 222 uses the metadata to determine which storage units need to be accessed to retrieve data for processing a particular task or job. A monitor and workload analyzer 224 oversees processes performed by the compute service manager 108 and manages the distribution of tasks (e.g., workload) across the virtual warehouses and execution nodes in the execution platform 110. The monitor and workload analyzer 224 also redistributes tasks, as needed, based on changing workloads throughout the data platform 102 and may further redistribute tasks based on a user (e.g., “external”) query workload that may also be processed by the execution platform 110. The configuration and metadata manager 222 and the monitor and workload analyzer 224 are coupled to a data store 226. Data store 226 in FIG. 2 represents any data repository or device within the data platform 102. For example, data store 226 may represent caches in execution platform 110, storage devices in data storage 104, the metadata data store 114, or any other storage device or system.

As shown, transaction manager 230 is included in the compute service manager 108. The transaction manager 230 receives a job that may be divided into one or more discrete transactions, e.g., transaction 0, transaction 1, transaction 2, transaction 3, and so forth through transaction (n). In an embodiment, each transaction includes one or more tasks or operations (e.g., read operation, write operation, database statement, user defined function, and the like) to perform. The transaction manager 230 receives the job and determines transactions that may be carried out to execute the job. The transaction manager 230 is configured to determine the one or more discrete transactions, such as transaction 0, transaction 1, transaction 2, transaction 3, and so forth, based on applicable rules and/or parameters, and assigns transactions.

In an embodiment, the subject system provides concurrency control and isolation for executing transactions (e.g., a series of SQL Statements within a SQL Transaction) against linearizable storage (e.g., a linearizable key-value store, NoSQL database, an OLAP database or data warehouse). A transaction as referred to herein includes a group of operations executed atomically. In an example, such transactions may include read and write operations but can also include operations such as increment, decrement, compare-and-swap, and the like. Further, it is appreciated that linearizable storage may include any type of distributed database (e.g., Apache HBase, Foundation DB, and the like).

In an example, the transaction manager 230 utilizes a linearizable storage, provided by data storage 104, for managing and processing transactions as described herein. In an embodiment, the transaction manager 230 implements a read committed model for performing transactions. As referred to herein, a read committed model can refer to a model that ensures that all read operations performed in a given transaction sees a consistent snapshot of the database (e.g., reading a last set of committed values that existed when the read operation commenced), and the transaction itself successfully commits only if no updates that the transaction has made results in write-write conflicts with any concurrent transactions. In addition, transaction manager 230 implements a two-level transaction hierarchy, where a top-level transaction corresponds to a SQL transaction, and a nested transaction corresponds to a SQL statement within the parent SQL transaction. A given nested transaction can perform operations, such as reads and writes, and can perform a rollback and restart execution zero or more times before succeeding. Upon transaction commit, write operations can become visible, and write locks held by each statement can be released. As mentioned before, the subject system provides concurrency control and isolation for executing a series of SQL Statements within a SQL Transaction against a linearizable storage.

The transaction manager 230 is configured to provide a concurrency control mechanism that can be understood as a combination of multi-version concurrency control for read operations (MVCC) and locking for write operations. The subject system provides read committed isolation where each statement may execute against a different snapshot of the database (e.g., data storage 104), with write locks held until transaction commit.

A transaction can encompass one or more statements, with each statement acquiring an immutable database snapshot through its statement read timestamp (readTs). To manage transaction and statement statuses, a transaction status table (TST) is utilized.

In addition, as mentioned above, the compute service manager 108 includes an adaptive bulk load analyzer 109 that is responsible for performing operations related to implementing an adaptive bulk load for queries on hybrid tables, as discussed further herein. Further details regarding the functionality of the adaptive bulk load analyzer 109 are discussed below.

As mentioned herein, a hybrid table refers to a type of table that stores data as key-value pairs, optimized for both operational and analytical workloads, and such a hybrid table can be managed by a transaction manager (e.g., transaction manager 230) that provides multi-statement transaction semantics with read-committed isolation. In an implementation, hybrid tables leverage linearizable storage such as Foundation DB (FDB) for data storage.

Embodiments of the subject technology enable an adaptive and dynamic approach to improving the performance of insert and copy operations on hybrid tables, especially when dealing with large datasets. More specifically, the subject system employs an adaptive and dynamic approach to optimize execution based on varying scenarios, such as different table and data sizes.

Example aspects include:
1. Adaptive Plan: The subject system dynamically chooses the best execution approach at runtime, optimizing performance for various table and data sizes.
2. Support for Foreign Keys: Unlike existing solutions, the subject system supports loading data into tables with foreign keys without requiring application modifications.
3. Enhanced Performance and Cost Efficiency: The subject system achieves significant improvements in write throughput and cost savings compared to some existing approaches.
4. Integration with a FDB Bulk Load API: The use of the FDB bulk load API allows for fast loading into both empty and non-empty tables, with efficient conflict and constraint checking.

Embodiments of the subject technology provide the following example advantages.
1. Extends fast bulk load to insert and copy statements.
2. Supports tables with foreign keys.
3. Utilizes an adaptive plan to dynamically select the best approach at runtime.
4. Achieves write throughput improvements and cost savings compared to some existing implementations.

In an embodiment, a FDB bulk load API, supporting loading into empty and non-empty tables is provided. Some features include:
1. Adaptive Switch operator to decide between different plans based on data size.
2. Conflict and constraint checks for foreign keys during bulk load.
3. Handling of bulk load conflicts and retries, with a fallback to a native insert, if necessary.

The subject technology can be understood as providing two levels of adaptiveness for bulk loading. A first level is on a compilation side (e.g., during compilation of a given query), which is dependent on a cardinality estimate of a query. A cardinality estimate refers to a predicted number of rows that will be processed or returned by a particular operation or query. For techniques described herein related to the hybrid table bulk load, cardinality estimation is utilized at least at compile time to determine whether a load operation should use a hybrid bulk load path or a standard (e.g., native) insert path. A second level of adaptiveness for bulk loading relates to runtime adaptiveness of the compiled query, which is discussed in more detail below.

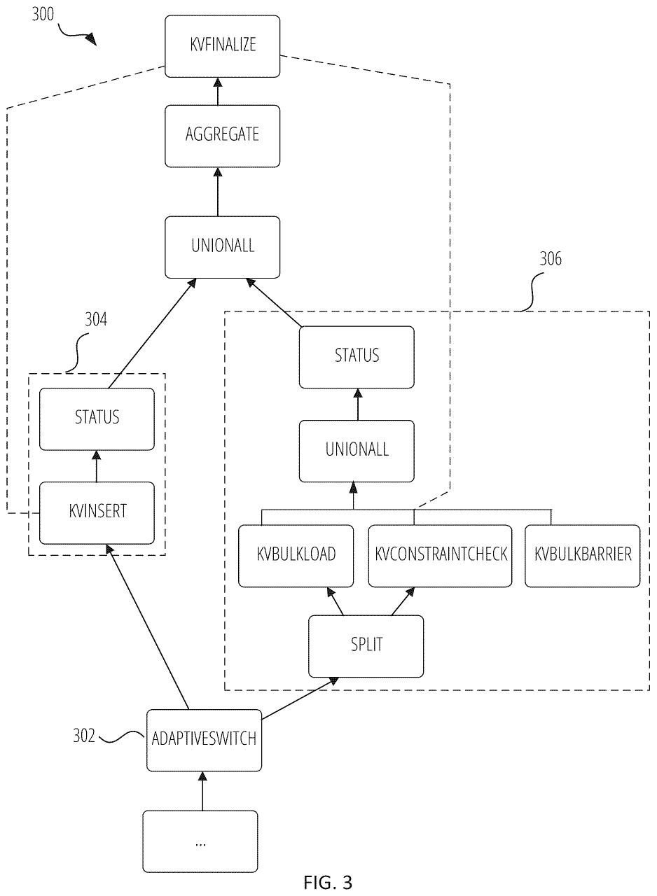

In an example, an initial query plan is generated for a given query, and this query plan is subsequently optimized (e.g., by job optimizer 214) to generate an updated query plan as discussed in the following. In an example, if a query compiler (e.g., job optimizer 214) determines that a cardinality estimation of a query is less than or equal to a predetermined threshold number of rows (e.g., a particular threshold value), the query can be compiled to solely include a native insert subplan and without a hybrid bulk load subplan. In an implementation, adaptive bulk load analyzer 109 can perform such a determination based on the cardinality estimate. Alternatively, if the query compiler (e.g., job optimizer 214 or adaptive bulk load analyzer 109) determines that a cardinality estimation of a query greater than a predetermined threshold number of rows, then the query can be compiled to include a native insert subplan (e.g., discussed below in connection with FIG. 3) and also include a hybrid bulk load subplan (e.g., also discussed below in connection with FIG. 3) in a (combined) query plan.

FIG. 3 illustrates an example of a query plan providing an adaptive bulk load, in accordance with an embodiment of the subject technology.

In query plan 300, there are various operators including KvFinalize, Aggregate, UnionAll, KvBulkLoad, KvConstraintCheck, KvBulkBarrier, KvInsert, and AdaptiveSwitch. Query plan 300 represents a query execution plan that incorporates both standard insert and bulk load paths.

As mentioned above, a second level of adaptiveness for bulk loading relates to runtime adaptiveness. For example, during runtime (e.g., execution) of the query, a second level decision is made based on an amount of data received during execution, which determines one of two different branches (e.g., native insert subplan 304 or bulk load subplan 306) for forwarding the data.

Some key components of the query plan 300 include the following, which visually depicts how the query plan can dynamically choose between the standard insert and bulk load paths based on the data volume, allowing for optimized performance across different scenarios.

AdaptiveSwitch corresponding to adaptive switch operator 302: This is a decision-making component, which dynamically determines whether to route data to the either a standard insert path or hybrid bulk load path based at least in part on a volume of data (e.g., number of rows and the like) being processed.

Path corresponding to native insert subplan 304 (left side): This represents the standard insert path, which includes:
KvInsert operator: native insert (e.g., loading) operation involving inserting data row by row into database tables.
Status operator: reports the status or progress of the loading operation, and may collect and provide information about the number of rows processed, or other relevant metrics related to the native insert operation.

Path corresponding to bulk load subplan 306 (right side): This represents the bulk load path, which includes:
Split operator: pushes data to different consumers to enable parallel processing (for different purposes)
KvBulkLoad operator: this operator is performed first, and rewrites customer data to a hybrid table format, which is then persisted to storage (e.g., disk, and the like). Any generated files are uploaded to cloud storage (e.g., data storage 104).
KvConstraintCheck operator: this operator is performed third, awaits KvBulkBarrier operator to complete, and performs a deferred foreign key constraint check which awaits the completion of the KvBulkLoad operator, ensuring that all bulk load operations are complete.
KvBulkBarrier operator: this operator is performed second (e.g., after KVBulkLoad operator), and is responsible for performing the bulk load operation when the bulk load path is chosen
Status operator: reports the status or progress of the loading operation, and may collect and provide information about the number of rows processed or other relevant metrics related to the bulk load operation.

Execution of query plan 300 concludes with UnionAll (e.g., union all), Aggregate (e.g., aggregation), and KvFinalize (e.g., finalize to complete the query) operators corresponding to respective (final) operations for the query.

In the query plan 300, AdaptiveSwitch is an operator (e.g., adaptive switch operator 302) configured to buffer input data and determine a number of rows that are being received (e.g., a row count). When the buffered row count surpasses a predetermined threshold value or a total buffered size, the input data is routed to bulk load subplan 306 through a right output link.

To ensure a coordinated decision across all instances (e.g., one or more execution nodes that are executing respective queries), the adaptive switch operator 302 employs a barrier mechanism. If the global row count remains equal to or below the predetermined threshold value and no instances have initiated a data transfer to bulk load subplan 306, adaptive switch operator 302 directs the buffered input data to native insert subplan 304.

The aforementioned approach can require a pause in the pipeline, even when native insert subplan 304 might be the optimal choice, as the subject system awaits a globally agreed-upon decision. In scenarios where particular RSOs (rowset operators) opt to transmit data to KvBulkLoad of bulk load subplan 306, the remaining RSOs defer processing until a terminate phase corresponding to a final stage of query execution. In an example, a rowset operator (RSO) can process sets of rows as part of a distributed query plan, where a given RSO is utilized to perform various operations on data during query execution, such as filtering, sorting, aggregating, and in this case, adaptive switching between different data loading strategies.

In an implementation, a gossip protocol between workers can allow for more efficient coordination and potentially reduce the delay in processing for remaining RSOs. Such a gossip protocol enables sharing information across multiple execution nodes or processes without requiring centralized coordination, thereby improving the efficiency of the adaptive bulk load process discussed herein, and achieving a more dynamic and responsive decision-making process across the distributed components (e.g., various execution nodes, and the like), leading to better utilization of resources and faster execution times.

The foreign key constraint check (e.g., KvConstraintCheck operator) mentioned above, in an implementation, can perform the constraint check based on an entire blob (e.g., Binary Large Object that includes a collection of binary data stored as a single entity) using a particular bulk read operation referred to as a blob scan in which such a blob scan(s) are used to batch read referencing indexes, which can optimize the constraint checking process. By using blob scans, the subject system can read larger chunks of data at once from the blob, reducing the number of individual read operations and potentially improving performance.

In an implementation, the AdaptiveSwitch node (e.g., adaptive switch operator 302) references the outcome of a previous startBulkLoad call (discussed further below) to ascertain table emptiness. If the table is found to be non-empty, the adaptive switch operator 302 directs the data to the native insert subplan 304.

In an implementation, “startBulkLoad” refers to an API call used to initiate a bulk load process for large data insertions or copies into empty table ranges.

More specifically, startBulkLoad is called (e.g., by sending a request, or making an API call) to:
1. Determine if a table is empty and suitable for bulk loading.
2. Initialize the bulk load process with the FDB bulk load API by initializing a bulk load operation for a specified range, which can correspond to the entire empty table. The specified range (e.g., bulk load range) refers to a specific portion of a table that is targeted for a bulk load operation where such a portion of the table is understood as an “empty” range that contains no data.
3. If the initialization is successful, establish (e.g., take) an exclusive write lock on a targeted bulk load range (e.g., the specified range).

The result of the startBulkLoad call is used by the AdaptiveSwitch operator (e.g., adaptive switch operator 302) to decide whether to proceed with the bulk load path corresponding to bulk load subplan 306 or fall back to the standard insert path corresponding to native insert subplan 304. For example, if startBulkLoad fails, e.g., due to the table not being empty, the subject system reverts to the standard insert method of native insert subplan 304. This fallback mechanism ensures that the loading operation can proceed even if the bulk load cannot be initiated for the specified range.

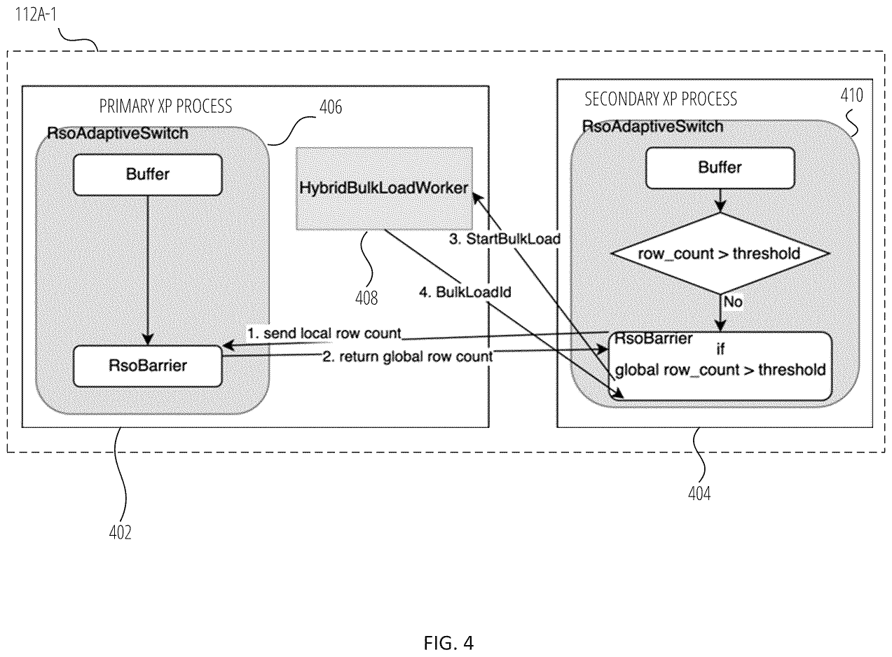

FIG. 4 illustrates an example of a data processing flow for adaptive bulk load execution involving various components of the data platform 102, in accordance with an embodiment of the subject technology. More specifically, FIG. 4 shows how the adaptive bulk load execution process works across multiple execution node processes, showcasing the decision-making flow and communication between components to determine whether to proceed with bulk loading.

In the example of FIG. 4, a data processing flow of an adaptive bulk load execution process is depicted for a given execution node (e.g., execution node 112A-1) that includes a primary execution node process 402 and a secondary execution node process 404. The secondary execution node process 404 is executing a query plan (e.g., query plan 300) that includes a standard insert path (e.g., native insert subplan 304 of query plan 300) and a bulk load path (e.g., bulk load subplan 306 of query plan 300).

The following is a further discussion of components shown in FIG. 4.

The primary execution node process 402 (“Master XP Process”) includes:
an RSO adaptive switch 406 component, which includes a Buffer component for receiving data for processing by operator(s) from the query plan, and an RsoBarrier component for communication and synchronization among different execution processes or components executing within such execution processes. In an implementation, RSO adaptive switch 406 component will be executed in a thread, and hybrid bulk load worker 408 (“HybridBulkLoadWorker”) is a separate worker thread. A process will spawn many threads to process different RSOs, but only one thread for hybrid bulk load worker 408.

The secondary execution node process 404 (“Secondary XP Process”) includes:
an RSO adaptive switch 410 component, which includes a Buffer component for receiving data for processing by operator(s) from the query plan, and an RsoBarrier component for communication and synchronization among different execution processes or components executing within such execution processes

A hybrid bulk load worker 408 (“HybridBulkLoadWorker”) is provided for handling requests from one or more secondary execution node processes 404. In an implementation, a query is scheduled to multiple execution nodes, and each execution node only includes one worker process for the query.

In the example of FIG. 4, RSO adaptive switch 410 is utilized to buffer data until a particular threshold number (e.g., number of rows) is reached, and then RSO adaptive switch 410 decides whether to use a bulk load path or standard insert path based on the amount of data received (e.g., the number of rows).

When RSO adaptive switch 410 determines that a row count exceeds a particular threshold number, a startBulkLoad request is sent from RSO adaptive switch 410 of secondary execution node process 404 (e.g., the “Secondary XP Process”) to hybrid bulk load worker 408 (e.g., “HybridBulkLoadWorker”). Hybrid bulk load worker 408 performs the aforementioned operations discussed in connection with the startBulkLoad request. If the startBulkLoad request is successful (e.g., processed successfully), hybrid bulk load worker 408 sends a BulkLoadId (bulk load identifier) to RSO adaptive switch 410, which is then used for subsequent bulk load operations by secondary execution node process 404. For example, the BulkLoadId enables the subject system to track and manage the progress of individual bulk load operations, especially when multiple operations might be occurring concurrently. Moreover, the bulk load ID is associated with the exclusive write lock taken on the targeted bulk load range, which ensures that the specified table range remains empty and protected from concurrent writes during the bulk load operation. In a distributed execution environment provided by the subject system, the bulk load ID can help coordinate actions across multiple execution node processes, including being used to distribute the bulk load information to multiple KvBulkLoad operators.

The following further summarizes the decision flow described above:
The RSO adaptive switch 410 of secondary execution node process 404 determines if a row count exceeds a threshold number based on buffered input data.
If the row count exceeds the threshold number, RSO adaptive switch 410 sends a startBulkLoad request to the hybrid bulk load worker 408 to initiate the bulk load path (e.g., bulk load subplan 306). Alternatively, if the row count does not exceed the threshold number, the row count is provided to RsoBarrier in RSO adaptive switch 406, which sends a current buffer count to primary execution node process 402. After primary execution node process 402 receives all row counts from each secondary process, RsoBarrier of primary execution node process 402 provides a decision to RsoBarrier of secondary execution node process 404. In an example, secondary execution node process 404 did not exceed the threshold, but globally the threshold was exceeded. In this case, a startBulkLoad request will be sent while the RsoBarrier of secondary execution node process 404 is still processing after receiving the decision from primary execution node process 402.
The hybrid bulk load worker 408 sends a BulkLoadId to RSO adaptive switch 410 if the startBulkLoad request is successful.
RSO adaptive switch 410 determines that the bulk load path of the query plan is to be utilized for processing the buffered input data, and sends the buffered input data to a bulk load subplan of the query plan for processing (e.g., performing a bulk load operation(s) by a bulk load operator).

In an example, a startBulkLoad request is initiated by a given secondary execution node process. In a case where there are other secondary execution node processes, if one secondary execution node process fails to reach the threshold locally, the secondary execution node process will wait in the later RsoBarrier for the global decision. By that time, the secondary execution node process will receive the message from primary execution node process 402 that startBulkLoad is required, which will then request for such information. Moreover, in an implementation, primary execution node process 402 commences startBulkLoad only once, where any remainder of the request will reach from a cached result.

The following discussion relates to constraint checking within the context of bulk loading.

To ensure proper foreign key constraint checking during bulk load operations, the subject system uses an approach that employs a different write timestamp (writeTs) than the write timestamp in a given key. In this example, the constraint checking can involve the following steps related to various operators as described in the following.

A rsoKvConstraint operator waits for rsoKvBulkBarrier to complete, ensuring that all bulk load operations have finished.

As part of the rsoKvConstraint initialization, each execution node worker process obtains a current FDB read version (timestamp). This timestamp will serve as the writeTs for conflict checking purposes. For example, if Transaction 1 is about to read a key range, it will store this timestamp (e.g., ts5) for subsequent conflict checks.

The subject system processes each foreign key (FK) constraint individually within the rsoKvConstraint operation. It iterates through each foreign key index entry, using the locally stored writeTs (e.g., ts5) to check for range conflicts in the referencing table via a checkConflictRange API. If the stored writeTs is greater than the tuple's writeTs (e.g., ts5>1_ts2), the subject system will detect a conflict and report an error to the compute service manager 108 component for retry.

In the event of conflicts, a KvTxnRetryManager handles error cases as described in the following discussion.

If the bulk load query fails with an OTHER_INTERNAL_ERROR, the subject system will not attempt a retry at the execution node. Instead, the subject system initiates a job retry if permitted by compute service manager 108.

For all other error cases, bulk load queries will be subject to the same error handling procedures as other Data Manipulation Language (DML) operations.

This approach ensures that foreign key constraints are properly enforced during bulk load operations while maintaining data consistency and integrity.

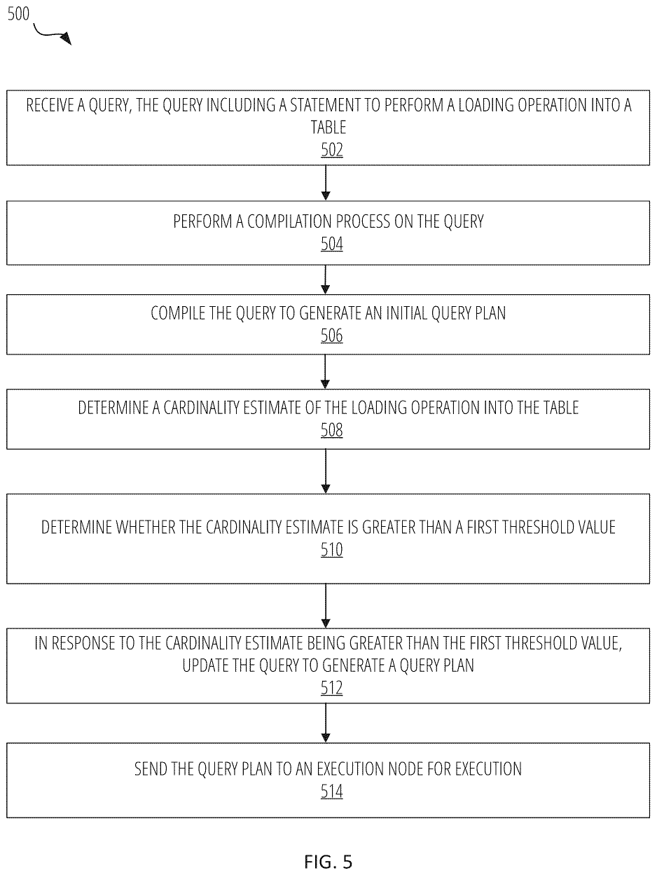

FIG. 5 is a flow diagram illustrating operations of a database system in performing a method 500, in accordance with some embodiments of the present disclosure. The method 500 may be embodied in computer-readable instructions for execution by one or more hardware components (e.g., one or more processors) such that the operations of the method 500 may be performed by components of data platform 102. Accordingly, the method 500 is described below, by way of example with reference thereto. However, it shall be appreciated that method 500 may be deployed on various other hardware configurations and is not intended to be limited to deployment within the data platform 102.

At operation 502, job compiler 212 receives a query, the query including a statement to perform a loading operation into a table.

At operation 504, job compiler 212 performs a compilation process on the query.

At operation 506, job compiler 212 compiles the query to generate an initial query plan.

At operation 508, adaptive bulk load analyzer 109 determines a cardinality estimate of the loading operation into the table.

At operation 510, adaptive bulk load analyzer 109 determines whether the cardinality estimate is greater than a first threshold value.

At operation 512, job optimizer 214, in response to the cardinality estimate being greater than the first threshold value, updates the initial query plan to generate a query plan, the query plan including a native insert subplan and a bulk load subplan.

At operation 514, adaptive bulk load analyzer 109 sends the query plan to an execution node for execution.

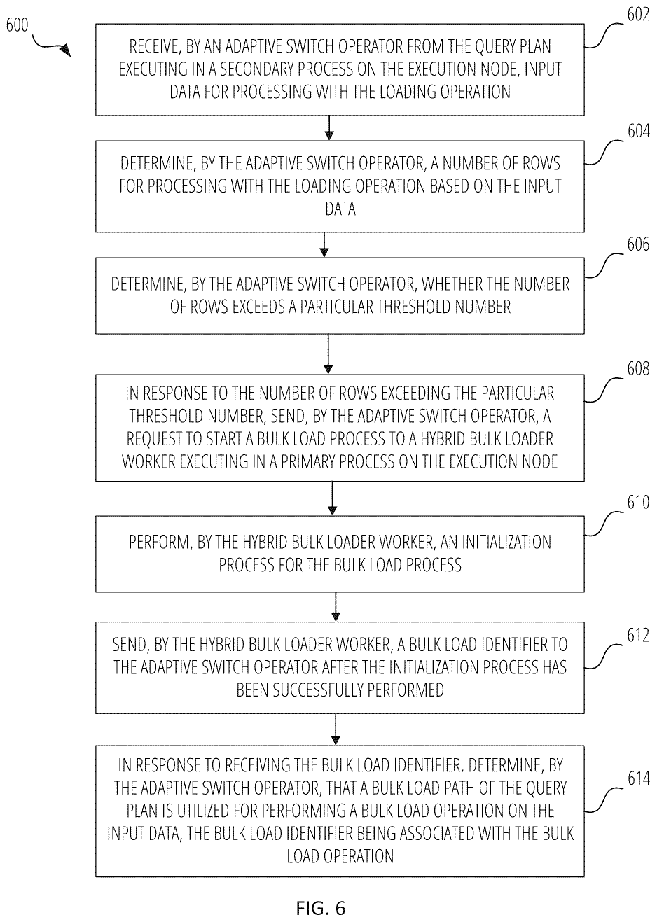

FIG. 6 is a flow diagram illustrating operations of a database system in performing a method 600, in accordance with some embodiments of the present disclosure. The method 600 may be embodied in computer-readable instructions for execution by one or more hardware components (e.g., one or more processors) such that the operations of the method 600 may be performed by components of data platform 102. Accordingly, the method 600 is described below, by way of example with reference thereto. However, it shall be appreciated that method 600 may be deployed on various other hardware configurations and is not intended to be limited to deployment within the data platform 102.

At operation 602, execution node 112A-1 receives, by an adaptive switch operator from the query plan executing in a secondary process on the execution node, input data for processing with the loading operation.

At operation 604, execution node 112A-1 determines, by the adaptive switch operator, a number of rows for processing with the loading operation based on the input data.

At operation 606, execution node 112A-1 determines, by the adaptive switch operator, whether the number of rows exceeds a particular threshold number.

At operation 608, execution node 112A-1, in response to the number of rows exceeding the particular threshold number, sends, by the adaptive switch operator, a request to start a bulk load process to a hybrid bulk loader worker executing in a primary process on the execution node.

At operation 610, execution node 112A-1 performs, by the hybrid bulk loader worker, an initialization process for the bulk load process.

At operation 612, execution node 112A-1 sends, by the hybrid bulk loader worker, a bulk load identifier to the adaptive switch operator after the initialization process has been successfully performed.

At operation 614, execution node 112A-1, in response to receiving the bulk load identifier, determines, by the adaptive switch operator, that a bulk load path of the query plan is utilized for performing a bulk load operation on the input data, the bulk load identifier being associated with the bulk load operation.

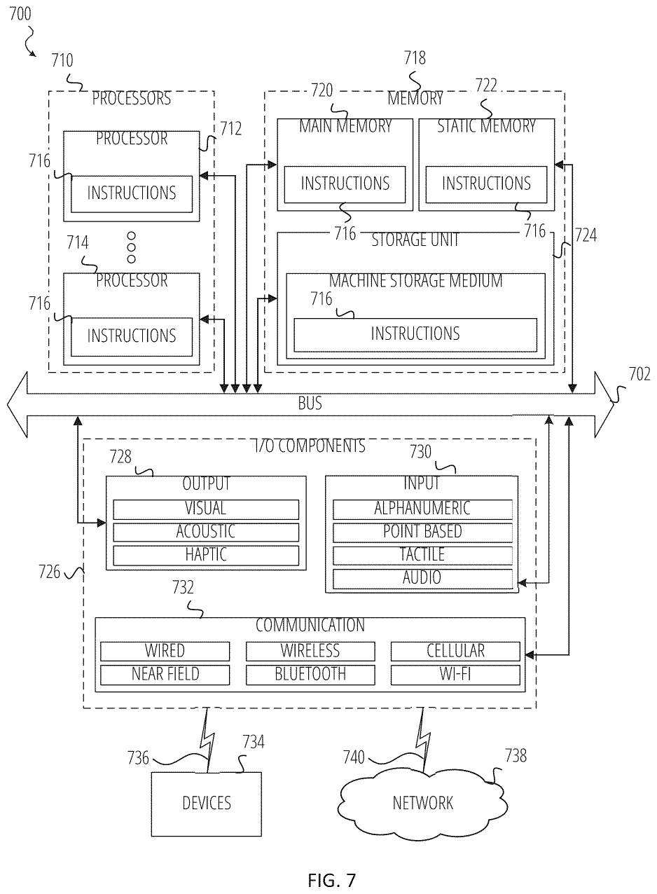

FIG. 7 illustrates a diagrammatic representation of a machine 700 in the form of a computer system within which a set of instructions may be executed for causing the machine 700 to perform any one or more of the methodologies discussed herein, according to an example embodiment. Specifically, FIG. 7 shows a diagrammatic representation of the 1800 in the example form of a computer system, within which instructions 716 (e.g., a software, a program, an application, an applet, an app, or other executable code) for causing the machine 700 to perform any one or more of the methodologies discussed herein may be executed. For example, the instructions 716 may cause the machine 700 to execute any one or more operations of the method(s) described before. As another example, the instructions 716 may cause the machine 700 to implement any one or more portions of the functionality illustrated in any one of at least some of the figures described herein. In this way, the instructions 716 transform a general, non-programmed machine into a particular machine that is specially configured to carry out any one of the described and illustrated functions of the data platform 102 such as the compute service manager 108 (or a component thereof such as the adaptive bulk load analyzer 109) or an execution node of the execution platform 110.

In some embodiments, the machine 700 operates as a standalone device or may be coupled (e.g., networked) to other machines. In a networked deployment, machine 700 may operate in the capacity of a server machine or a client machine in a server-client network environment or as a peer machine in a peer-to-peer (or distributed) network environment. The machine 700 may comprise, but not be limited to, a server computer, a client computer, a personal computer (PC), a tablet computer, a laptop computer, a netbook, a smart phone, a mobile device, a network router, a network switch, a network bridge, or any machine capable of executing the instructions 716, sequentially or otherwise, that specify actions to be taken by the machine 700. Further, while only a single machine 700 is illustrated, the term “machine” shall also be taken to include a collection of machines 700 that individually or jointly execute the instructions 716 to perform any one or more of the methodologies discussed herein.

The machine 700 includes processors 710, memory 718, and i/o components 726 configured to communicate with each other such as via a bus 702. In an example embodiment, the processors 710 (e.g., a central processing unit (CPU), a reduced instruction set computing (RISC) processor, a complex instruction set computing (CISC) processor, a graphics processing unit (GPU), a digital signal processor (DSP), an application-specific integrated circuit (ASIC), a radio-frequency integrated circuit (RFIC), another processor, or any suitable combination thereof) may include, for example, a processor 712 and a processor 714 that may execute the instructions 716. The term “processor” is intended to include multi-core processors 710 that may comprise two or more independent processors (sometimes referred to as “cores”) that may execute instructions 716 contemporaneously. Although FIG. 7 shows multiple processors 710, the machine 700 may include a single processor with a single core, a single processor with multiple cores (e.g., a multi-core processor), multiple processors with a single core, multiple processors with multiple cores, or any combination thereof.

The memory 718 may include a main memory 720, a static memory 722, and a storage unit 724, all accessible to the processors 710 such as via the bus 702. The main memory 720, the static memory 722, and the storage unit 724 store the instructions 716 embodying any one or more of the methodologies or functions described herein. The instructions 716 may also reside, completely or partially, within the main memory 720, within the static memory 722, within the storage unit 724, within at least one of the processors 710 (e.g., within the processor's cache memory), or any suitable combination thereof, during execution thereof by the machine 700.

The i/o components 726 include components to receive input, provide output, produce output, transmit information, exchange information, capture measurements, and so on. The specific i/o components 726 that are included in a particular machine 700 will depend on the type of machine. For example, portable machines such as mobile phones will likely include a touch input device or other such input mechanisms, while a headless server machine will likely not include such a touch input device. It will be appreciated that the i/o components 726 may include many other components that are not shown in FIG. 7. The i/o components 726 are grouped according to functionality merely for simplifying the following discussion and the grouping is in no way limiting. In various example embodiments, the i/o components 726 may include output components 728 and input components 730. The output components 728 may include visual components (e.g., a display such as a plasma display panel (PDP), a light emitting diode (LED) display, a liquid crystal display (LCD), a projector, or a cathode ray tube (CRT)), acoustic components (e.g., speakers), other signal generators, and so forth. The input components input components 730 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

Communication may be implemented using a wide variety of technologies. The i/o components 726 may include communication components 732 operable to couple the machine 700 to a network 738 or devices 734 via a coupling 740 and a coupling 736, respectively. For example, the communication components 732 may include a network interface component or another suitable device to interface with the network 738. In further examples, the communication components 732 may include wired communication components, wireless communication components, cellular communication components, and other communication components to provide communication via other modalities. The devices 734 may be another machine or any of a wide variety of peripheral devices (e.g., a peripheral device coupled via a universal serial bus (USB)). For example, as noted above, the machine 700 may correspond to any one of the compute service manager 108, the execution platform 110, and the devices 734 may include the data store 206 or any other computing device described herein as being in communication with the data platform 102 or the data storage 104.

The various memories (e.g., memory 718, main memory 720, static memory 722, and/or memory of the processor(s) processors 710 and/or the storage unit 724) may store one or more sets of instructions 716 and data structures (e.g., software) embodying or utilized by any one or more of the methodologies or functions described herein. These instructions 716, when executed by the processor(s) processors 710, cause various operations to implement the disclosed embodiments.

As used herein, the terms “machine-storage medium,” “device-storage medium,” and “computer-storage medium” mean the same thing and may be used interchangeably in this disclosure. The terms refer to a single or multiple storage devices and/or media (e.g., a centralized or distributed database, and/or associated caches and servers) that store executable instructions and/or data. The terms shall accordingly be taken to include, but not be limited to, solid-state memories, and optical and magnetic media, including memory internal or external to processors. Specific examples of machine-storage media, computer-storage media, and/or device-storage media include non-volatile memory, including by way of example semiconductor memory devices, e.g., erasable programmable read-only memory (EPROM), electrically erasable programmable read-only memory (EEPROM), field-programmable gate arrays (FPGAs), and flash memory devices; magnetic disks such as internal hard disks and removable disks; magneto-optical disks; and CD-ROM and DVD-ROM disks. The terms “machine-storage medium,” “computer-storage medium,” and “device-storage medium” specifically exclude carrier waves, modulated data signals, and other such media, at least some of which are covered under the term “signal medium”discussed below.

In various example embodiments, one or more portions of the network 738 may be an ad hoc network, an intranet, an extranet, a virtual private network (VPN), a local-area network (LAN), a wireless LAN (WLAN), a wide-area network (WAN), a wireless WAN (WWAN), a metropolitan-area network (MAN), the Internet, a portion of the Internet, a portion of the public switched telephone network (PSTN), a plain old telephone service (POTS) network, a cellular telephone network, a wireless network, a Wi-Fi® network, another type of network, or a combination of two or more such networks. For example, the network 738 or a portion of the network 738 may include a wireless or cellular network, and the coupling 740 may be a Code Division Multiple Access (CDMA) connection, a Global System for Mobile communications (GSM) connection, or another type of cellular or wireless coupling. In this example, the coupling 740 may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High-Speed Packet Access (HSPA), Worldwide Interoperability for Microwave Access (WiMAX), Long Term Evolution (LTE) standard, others defined by various standard-setting organizations, other long-range protocols, or other data transfer technology.

The instructions 716 may be transmitted or received over the network 738 using a transmission medium via a network interface device (e.g., a network interface component included in the communication components 732) and utilizing any one of a number of well-known transfer protocols (e.g., hypertext transfer protocol (HTTP)). Similarly, the instructions 716 may be transmitted or received using a transmission medium via the coupling 736 (e.g., a peer-to-peer coupling) to the devices 734. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 716 for execution by the machine 700, and include digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a manner as to encode information in the signal.

The terms “machine-readable medium,” “computer-readable medium,” and “device-readable medium” mean the same thing and may be used interchangeably in this disclosure. The terms are defined to include both machine-storage media and transmission media. Thus, the terms include both storage devices/media and carrier waves/modulated data signals.

The various operations of example methods described herein may be performed, at least partially, by one or more processors that are temporarily configured (e.g., by software) or permanently configured to perform the relevant operations. Similarly, the methods described herein may be at least partially processor implemented. For example, at least some of the operations of the methods described herein may be performed by one or more processors. The performance of certain of the operations may be distributed among the one or more processors, not only residing within a single machine, but also deployed across a number of machines. In some example embodiments, the processor or processors may be in a single location (e.g., within a home environment, an office environment, or a server farm), while in other embodiments the processors may be distributed across a number of locations.

Although the embodiments of the present disclosure have been described with reference to specific example embodiments, it will be evident that various modifications and changes may be made to these embodiments without departing from the broader scope of the inventive subject matter. Accordingly, the specification and drawings are to be regarded in an illustrative rather than a restrictive sense. The accompanying drawings that form a part hereof show, by way of illustration, and not of limitation, specific embodiments in which the subject matter may be practiced. The embodiments illustrated are described in sufficient detail to enable those skilled in the art to practice the teachings disclosed herein. Other embodiments may be used and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Thus, although specific embodiments have been illustrated and described herein, it should be appreciated that any arrangement calculated to achieve the same purpose may be substituted for the specific embodiments shown. This disclosure is intended to cover all adaptations or variations of various embodiments. Combinations of the above embodiments, and other embodiments not specifically described herein, will be apparent to those of skill in the art, upon reviewing the above description.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended; that is, a system, device, article, or process that includes elements in addition to those listed after such a term in a claim is still deemed to fall within the scope of that claim.

1. A system comprising:
at least one hardware processor; and
a memory storing instructions that cause the at least one hardware processor to perform operations comprising:
receiving a query, the query including a statement to perform a loading operation into a table;
performing a compilation process on the query, the compilation process comprising:
compiling the query to generate an initial query plan;
determining a cardinality estimate of the loading operation into the table;
determining whether the cardinality estimate is greater than a first threshold value, the cardinality estimate being utilized at compile time to determine whether the loading operation should use a hybrid bulk load path or a native insert path;
in response to the cardinality estimate being greater than the first threshold value, updating the initial query plan to generate a query plan, the query plan including a native insert subplan and a bulk load subplan, the query plan comprising an adaptive plan that dynamically selects, based on data size determined at runtime during query execution, an execution of the native insert subplan or the bulk load subplan at runtime for optimizing performance of the loading operation for the table, the adaptive plan further including an adaptive switch operator that buffers input data during query execution and selects between the native insert subplan and the bulk load subplan based on a number of rows received during execution; and
sending the query plan to an execution node for execution.

2. The system of claim 1, wherein the operations further comprise:
in response to the cardinality estimate being less than or equal to the first threshold value, compiling the query to generate a second query plan, the second query plan including the native insert subplan.

3. The system of claim 1, wherein the cardinality estimate comprises a particular number of rows.

4. The system of claim 1, wherein the loading operation comprises a copy operation or an insert operation.

5. The system of claim 1, wherein the operations further comprise:
receiving, by an adaptive switch operator from the query plan executing in a secondary process on the execution node, input data for processing with the loading operation;
determining, by the adaptive switch operator, a number of rows for processing with the loading operation based on the input data;
determining, by the adaptive switch operator, whether the number of rows exceeds a particular threshold number;
in response to the number of rows exceeding the particular threshold number, sending, by the adaptive switch operator, a request to start a bulk load process to a hybrid bulk loader worker executing in a primary process on the execution node;
performing, by the hybrid bulk loader worker, an initialization process for the bulk load process;
sending, by the hybrid bulk loader worker, a bulk load identifier to the adaptive switch operator after the initialization process has been successfully performed; and
in response to receiving the bulk load identifier, determining, by the adaptive switch operator, that a bulk load path of the query plan is utilized for performing a bulk load operation on the input data, the bulk load identifier being associated with the bulk load operation.

6. The system of claim 5, wherein the operations further comprise:
sending the input data to a bulk load subplan of the query plan to perform the bulk load operation on the input data.

7. The system of claim 6, wherein the operations further comprise:
performing, using a bulk barrier operator, the bulk load operation on the input data.

8. The system of claim 7, wherein the operations further comprise:
performing, using a constraint check operator, a foreign key constraint check of the input data after the bulk load operation has completed.

9. The system of claim 5, wherein performing, by the hybrid bulk loader worker, the initialization process for the bulk load process comprises:
determining whether the table is empty;
initializing the bulk load operation for a specified range of the table; and
in response to initializing the bulk load operation being successful, establishing an exclusive write lock on the specified range.

10. The system of claim 9, wherein specified range of the table includes no data.

11. A method comprising:
receiving a query, the query including a statement to perform a loading operation into a table;
performing a compilation process on the query, the compilation process comprising:
compiling the query to generate an initial query plan;
determining a cardinality estimate of the loading operation into the table, the cardinality estimate being utilized at compile time to determine whether the loading operation should use a hybrid bulk load path or a native insert path;
determining whether the cardinality estimate is greater than a first threshold value;
in response to the cardinality estimate being greater than the first threshold value, updating the initial query plan to generate a query plan, the query plan including a native insert subplan and a bulk load subplan, the query plan comprising an adaptive plan that dynamically selects, based on data size determined at runtime during query execution, an execution of the native insert subplan or the bulk load subplan at runtime for optimizing performance of the loading operation for the table, the adaptive plan further including an adaptive switch operator that buffers input data during query execution and selects between the native insert subplan and the bulk load subplan based on a number of rows received during execution; and
sending the query plan to an execution node for execution.

12. The method of claim 11, further comprising:
in response to the cardinality estimate being less than or equal to the first threshold value, compiling the query to generate a second query plan, the second query plan including the native insert subplan.

13. The method of claim 11, wherein the cardinality estimate comprises a particular number of rows.

14. The method of claim 11, wherein the loading operation comprises a copy operation or an insert operation.

15. The method of claim 11, further comprising:
receiving, by an adaptive switch operator from the query plan executing in a secondary process on the execution node, input data for processing with the loading operation;
determining, by the adaptive switch operator, a number of rows for processing with the loading operation based on the input data;
determining, by the adaptive switch operator, whether the number of rows exceeds a particular threshold number;
in response to the number of rows exceeding the particular threshold number, sending, by the adaptive switch operator, a request to start a bulk load process to a hybrid bulk loader worker executing in a primary process on the execution node;
performing, by the hybrid bulk loader worker, an initialization process for the bulk load process;
sending, by the hybrid bulk loader worker, a bulk load identifier to the adaptive switch operator after the initialization process has been successfully performed; and
in response to receiving the bulk load identifier, determining, by the adaptive switch operator, that a bulk load path of the query plan is utilized for performing a bulk load operation on the input data, the bulk load identifier being associated with the bulk load operation.

16. The method of claim 15, further comprising:
sending the input data to a bulk load subplan of the query plan to perform the bulk load operation on the input data.

17. The method of claim 16, further comprising:
performing, using a bulk barrier operator, the bulk load operation on the input data.

18. The method of claim 17, further comprising:
performing, using a constraint check operator, a foreign key constraint check of the input data after the bulk load operation has completed.

19. The method of claim 15, wherein performing, by the hybrid bulk loader worker, the initialization process for the bulk load process comprises:
determining whether the table is empty;
initializing the bulk load operation for a specified range of the table; and
in response to initializing the bulk load operation being successful, establishing an exclusive write lock on the specified range.

20. A non-transitory computer-storage medium comprising instructions that, when executed by one or more processors of a machine, configure the machine to perform operations comprising:
receiving a query, the query including a statement to perform a loading operation into a
performing a compilation process on the query, the compilation process comprising:
compiling the query to generate an initial query plan;
determining a cardinality estimate of the loading operation into the table;
determining whether the cardinality estimate is greater than a first threshold value, the cardinality estimate being utilized at compile time to determine whether the loading operation should use a hybrid bulk load path or a native insert path;
in response to the cardinality estimate being greater than the first threshold value, updating the initial query plan to generate a query plan, the query plan including a native insert subplan and a bulk load subplan, the query plan comprising an adaptive plan that dynamically selects, based on data size determined at runtime during query execution, an execution of the native insert subplan or the bulk load subplan at runtime for optimizing performance of the loading operation for the table, the adaptive plan further including an adaptive switch operator that buffers input data during query execution and selects between the native insert subplan and the bulk load subplan based on a number of rows received during execution; and
sending the query plan to an execution node for execution.
